(19) United States
(12) Patent Application Publication
(10) Pub. No.: US 2025/0050318 A1
(43) Pub. Date: Feb. 13, 2025

(54) RHODIUM-FREE TWC CATALYTIC ARTICLE

(71) Applicant: BASF CORPORATION, Florham Park, NJ (US)

(72) Inventors: Chenghao SUN, Shanghai (CN); Xiaoshuang YANG, Shanghai (CN); Chengwei SONG, Shanghai (CN); Shau Lin CHEN, Shanghai (CN); Gianluca VOLANTE, Hannover (DE); Xiaolai ZHENG, Iselin, NJ (US); Markus KINNE, Hannover (DE)

(21) Appl. No.: 18/723,684

(22) PCT Filed: Dec. 26, 2022
(86) PCT No.: PCT/CN2022/141862

§ 371 Date: Jun. 24, 2024

(30) Foreign Application Priority Data
Dec. 27, 2021 (WO) PCT/CN2021/141661

(51) Int. Cl. B01J 35/00; B01D 53/94; B01J 21/04; B01J 23/10; B01J 23/63; B01J 37/00; B01J 37/02; B01J 37/08; F01N 3/10; F01N 3/28

(52) U.S. Cl. CPC B01J 35/19; B01D 53/945; B01D 53/9472; B01J 21/04; B01J 23/10; B01J 23/63; B01J 37/0009; B01J 37/0236; B01J 37/0244; B01J 37/0248; B01J 37/086; F01N 3/101; F01N 3/2803; B01D 2255/1021; B01D 2255/1023; B01D 2255/9032; B01D 2255/908; B01D 2255/9155; B01D 2257/404; B01D 2257/502; B01D 2257/702; B01D 2258/014; F01N 2370/02; F01N 2510/0684

(57) ABSTRACT

The present invention relates to a rhodium-free TWC catalytic article, which comprises a catalyst composition coat on a substrate, wherein the catalyst composition coat comprises, —a first region comprising i). a top layer comprising a first platinum component and a first palladium component, each being present in supported form, and ii). a bottom layer comprising a second platinum component in supported form, and—optionally, a second region located downstream of the first region, and comprising iii). a top layer comprising a third platinum component in supported form, and iv). a bottom layer comprising a fourth platinum component in supported form. The present invention relates to an exhaust treatment system comprising the rhodium-free TWC catalytic article.

### FIELD OF THE INVENTION

The present invention relates to a rhodium-free TWC catalytic article useful for treatment of engine exhaust gases and an exhaust treatment system comprising the rhodium-free TWC catalytic article. Particularly, the present invention relates to a rhodium-free catalytic article useful for treatment of exhaust gases from stoichiometric engines, especially motorcycle engines.

### BACKGROUND OF THE INVENTION

Engine exhaust substantially consists of particulate matter and gaseous pollutants such as unburned hydrocarbons (HC), carbon monoxide (CO) and nitrogen oxides (NOx). For stoichiometric engines operating near the optimum air/fuel ratio, such as gasoline engines, three-way conversion catalysts (hereinafter interchangeably referred to as TWC catalyst or TWC) are typically used to simultaneously oxidize unburnt hydrocarbons and carbon monoxide and reduce nitrogen oxides. TWC catalysts are known effective near stoichiometric conditions, under which the basic reactions including reduction and oxidation may be exemplified as follows,

2NO+2CO→N₂+2CO₂

2CO+O₂→2CO₂

2C₂H₆+7O₂→4CO₂+6H₂O.

TWC catalysts generally utilize platinum group metals (PGMs), e.g., rhodium (Rh), platinum (Pt) and palladium (Pd), as catalytically active species. It is known that Pt and Pd are mainly responsible for catalysis of HC and CO oxidation and Rh is mainly responsible for catalysis of NOx reduction. For that reason, the three PGMs Pt, Pd and Rh were used in combination in most TWC catalysts, although some TWC catalysts may possibly comprise rhodium and only one of platinum and palladium as catalytically active species. Rhodium plays an important role in TWC catalysts for its NOx reduction capability. However, the price of rhodium is becoming crazily high, being almost 15 times higher than Pt and 7 times higher than Pd nowadays, and the price is expected to stay as the highest compared to Pt and Pd. It will be valuable to explore the effectiveness of Pt and Pd and eliminate Rh in TWC catalysts for exhaust treatment.

Some rhodium-free catalysts for the treatment of exhaust gases has been reported. For example, a Pt/Pd diesel oxidation catalyst (DOC) with CO/HC light-off and HC storage function was described in U.S. Pat. No. 7,576,031B2, which comprises two distinct washcoat layers containing two distinctly different ratios of Pt:Pd. It was not described that the Pt/Pd diesel oxidation catalyst may be useful as TWC catalysts. Actually, it can be reasonably expected that the Pt/Pd diesel oxidation catalyst will not be effective for TWC applications, since different catalyst performances and thus catalyst compositions are required for DOC applications and TWC applications. For example, the Pt/Pd diesel oxidation catalyst in the patent application must comprise a HC storage component for treating oxidative exhaust gases from diesel engines, while TWC catalysts do not need such a HC storage function as the exhaust gases to be treated is non-oxidative.

Thus, there is a need to provide a TWC catalyst which eliminates the use of expensive rhodium and is still effective for removal of HC, CO and NOx from stoichiometric engine exhaust gases, without undesirable degradation of catalyst performance.

### SUMMARY OF THE INVENTION

The object of the present invention is to provide a rhodium-free TWC catalytic article, which has at least comparable catalytic performance in terms of abatement of HC, CO and NOx, compared with rhodium-containing counterparts.

It has been surprisingly found that the object of the present invention was achieved by a layered catalytic article comprising a Pt/Pd-containing top layer and a Pt-containing bottom layer at least in the inlet region of the catalytic article.

Accordingly, in one aspect, the present invention provides a rhodium-free TWC catalytic article, which comprises a catalyst composition coat on a substrate, wherein the catalyst composition coat comprises,
a first region comprising
   i. a top layer comprising a first platinum component and a first palladium component, each being present in supported form, and
   ii. a bottom layer comprising a second platinum component in supported form, and
optionally, a second region located downstream of the first region, and comprising
   iii. a top layer comprising a third platinum component in supported form, and
   iv. a bottom layer comprising a fourth platinum component in supported form.

In another aspect, the present invention provides an exhaust treatment system comprising the rhodium-free TWC catalytic article as described herein located downstream of a stoichiometric engine, particularly a gasoline engine.

In a further aspect, the present invention provides a method for treating an exhaust stream from a stoichiometric engine, which includes contacting the exhaust stream with the rhodium-free TWC catalytic article or the exhaust treatment system as described herein.

### BRIEF DESCRIPTION OF THE DRAWINGS

FIG. 1A is a schematic representation of the layered configuration of the catalytic module according to Example 1.1.

FIG. 1B is a schematic representation of the layered configuration of the catalytic module according to Example 1.2.

FIG. 1C is a schematic representation of the layered configuration of the catalytic module according to Example 1.3.

FIG. 2 is a schematic representation of a catalytic article configuration of comparative sample R1 as illustrated in Example 2.

FIG. 3 is a schematic representation of a catalytic article configuration of comparative sample R2 as illustrated in Example 2.

FIG. 4 is a schematic representation of a catalytic article configuration of comparative sample R3 as illustrated in Example 2.

FIG. 5 is a schematic representation of a catalytic article configuration of comparative sample R4 as illustrated in Example 2.

FIG. 6 is a schematic representation of a catalytic article configuration of comparative sample R5 as illustrated in Example 2.

FIG. 7 is a schematic representation of a catalytic article configuration of inventive sample S1 as illustrated in Example 2.

FIG. 8 is a schematic representation of a catalytic article configuration of inventive sample S2 as illustrated in Example 2.

FIG. 9 is a graph showing tail-pipe emissions in terms of NMHC, THC, CO and NOx after treatment of engine exhausts with each samples as illustrated in the Example 2.

### DETAILED DESCRIPTION OF THE INVENTION

The present invention will be described in detail hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or cognates may be embraced within “comprises” or cognates.

As used herein, the terms “palladium component” and “platinum component” are intended to describe the presence of respective platinum group metals in any possible valence state, which may be for example metal or metal oxide as the catalytically active form, or may be for example metal compound, complex or the like which, upon calcination or use of the catalyst, decomposes or otherwise converts to the catalytically active form.

As used herein, the term “rhodium-free” is intended to mean no rhodium component has been intentionally added or used in the TWC catalytic article as described herein. It will be appreciated by those of skill in the art that trace amounts of impurity rhodium from raw materials (e.g., platinum raw material) may impossibly be avoided. There is generally no more than 0.3% by weight, no more than 0.1% by weight, no more than 0.05% by weight, or no more than 0.01% by weight, based on the total loading of any PGMs.

As used herein, the term “support” refers to a material in form of particles, for receiving and carrying one or more platinum group metal components, and optionally one or more other components such as stabilizers, promoters and binders.

Herein, any reference to a platinum group metal component in “supported form” is intended to mean that the platinum group metal is supported on and/or in support particles.

Herein, any reference to a platinum component and a palladium component which are “supported together” is intended to mean the two platinum group metal components are supported on and/or in same support particles, for example by means of impregnation of respective precursors on the same support particles simultaneously or sequentially. It will be appreciated that both platinum and palladium may be found on and/or in a single support particle if those platinum and palladium components are supported together.

As used herein, the terms “exhaust”, “exhaust gas”, “exhaust stream” and the like refer to any engine effluents that may also contain particulate matter.

According to the first aspect of the present invention, a rhodium-free TWC catalytic article is provided, which comprises a catalyst composition coat on a substrate, wherein the catalyst composition coat comprises,
a first region comprising
   i. a top layer comprising a first platinum component and a first palladium component, each being present in supported form, and
   ii. a bottom layer comprising a second platinum component in supported form, and
optionally, a second region located downstream of the first region, and comprising
   iii. a top layer comprising a third platinum component in supported form, and
   iv. a bottom layer comprising a fourth platinum component in supported form.

Herein, any references to “first” and “second” within the context of the regions are intended to indicate the relative position of the regions, whereby the first region refers to a certain length of the catalyst composition coat extending from the inlet end in the longitudinal direction of the substrate, and the second region refers to a certain length of the catalyst composition coat extending downstream of the first region in the longitudinal direction of the substrate.

The catalyst composition coat in the rhodium-free TWC catalytic article according to the present invention may comprise only the first region. In this case, the catalyst composition coat may have a uniform composition from the inlet end to the outlet end in the longitudinal direction of the substrate.

Accordingly, in some embodiments, the rhodium-free TWC catalytic article according to the present invention comprises a catalyst composition coat on a substrate, which comprises,
i. a top layer comprising a first platinum component and a first palladium component, each being present in supported form, and
ii. a bottom layer comprising a second platinum component in supported form, both layers extending from an inlet end to an outlet end of the substrate.

Alternatively, the catalyst composition coat in the rhodium-free TWC catalytic article according to the present invention may comprise the second region located downstream of the first region.

Accordingly, in some other embodiments, the rhodium-free TWC catalytic article according to the present invention comprises a catalyst composition coat on a substrate, which comprises,
a first region comprising
   i. a top layer comprising a first platinum component and a first palladium component, each being present in supported form, and
   ii. a bottom layer comprising a second platinum component in supported form, and
a second region located downstream of the first region, and comprising
   iii. a top layer comprising a third platinum component in supported form, and
   iv. a bottom layer comprising a fourth platinum component in supported form.

In the rhodium-free TWC catalytic article according to the present invention, the top layer in the first region of the catalyst composition coat may comprise the first platinum component and the first palladium component in supported forms such that the first platinum component and the first palladium component are supported together or individually on one or more supports.

The top layer in the second region of the catalyst composition coat may or may not comprise a palladium component, i.e., a second palladium component, in supported form.

Accordingly, in some particular embodiments, the top layer in the second region of the catalyst composition coat comprises the third platinum component and a second palladium component, each being present in supported form. In this case, the third platinum component and the second palladium component may be supported together or individually on one or more supports.

In some other particular embodiments, the top layer in the second region of the catalyst composition coat is substantially free of a palladium component.

In the rhodium-free TWC catalytic article according to the present invention, the bottom layers in the first region and in the second region (when present) of the catalyst composition coat may have same or different layer compositions. Preferably, the bottom layers in the first region and in the second region have different layer compositions.

According to the present invention, the bottom layer, either in the first region or in the second region, is carried on the substrate and the top layer is carried on the bottom layer without any intermediate layers.

Preferably, the bottom layers in the first region and in the second region (when present) of the catalyst composition coat, may be substantially free of a palladium component, particularly substantially free of any platinum group metal components other than a platinum component.

Herein, reference to a region or layer that is “substantially free” of a platinum group metal (PGM) component is intended to mean no PGM component as specified has been intentionally added or used in the region or layer. It will be appreciated that trace amounts of impurity PGM(s) from raw materials may impossibly avoided. Moreover, migration of trace amounts of PGM(s) into the region or layer may inadvertently occur during loading, coating and/or calcining, such that trace amounts of the specified PGM(s) may be present in the region or layer as impurity. There will be generally less than 0.5% by weight, less than 0.25% by weight, or less than 0.1% by weight, of the specified PGM(s), based on the total loading of any PGMs in the region or layer.

When the catalyst composition coat of the rhodium-free TWC catalytic article according to the present invention comprises the first region and the second region, the two regions may be carried on a single piece of substrate or carried on respective pieces of substrate. The first region and the second region are adjacent to each other, which may be exactly adjoining, but may also non-intentionally be interrupted with a gap for example in the case that the two regions are carried on two pieces of substrate, or non-intentionally be overlapped for example in the case that the two regions are carried on a single piece of substrate.

It is to be further understood that, in the case that the first region and the second region of the catalyst composition coat are carried on respective pieces of substrate, the pieces of substrate are arranged longitudinally such that the exhaust stream to be treated passes through the first piece of substrate carrying the first region of the catalyst composition coat and then the second piece of substrate carrying the second region of the catalyst composition coat.

In the catalyst composition coat of the rhodium-free TWC catalytic article according to the present invention, any known supports useful for platinum group metal components in TWC catalytic articles may be used without any restrictions. The supports for platinum components or palladium components in different layers or in different regions in the catalyst composition coat may be the same or different. Moreover, the supports for a platinum component and a palladium component in the same layer of a region of the catalyst composition coat may be the same or different.

As useful support materials for the platinum group metal components in the rhodium-free TWC catalytic article according to the present invention, refractory metal oxides, oxygen storage components and any combinations thereof may be mentioned.

The refractory metal oxide, a widely used support material for platinum group metal components in catalytic articles for exhaust treatment, is generally a high surface area alumina-based material, zirconia-based material or a combination thereof. Within the context of the present invention, “alumina-based material” refers to a material comprising alumina as a base and optionally a dopant. Similarly, “zirconia-based material” refers to a material comprising zirconia as a base and optionally a dopant.

Suitable examples of the alumina-based materials include, but are not limited to alumina, for example a mixture of the gamma and delta phases of alumina which may also contain substantial amounts of eta, kappa and theta alumina phases, lanthana doped alumina, baria doped alumina, ceria doped alumina, zirconia doped alumina, ceria-zirconia doped alumina, lanthana-zirconia doped alumina, baria-lanthana doped alumina, baria-ceria doped alumina, baria-zirconia doped alumina, baria-lanthana-neodymia doped alumina, lanthana-ceria doped alumina, and any combinations thereof.

Suitable examples of the zirconia-based materials include, but are not limited to zirconia, lanthana doped zirconia, yttria doped zirconia, neodymia doped zirconia, praseodymia doped zirconia, titania doped zirconia, titania-lanthana doped zirconia, lanthana-yttria doped zirconia, and any combinations thereof.

Particularly, the refractory metal oxide useful as the support may be selected from baria doped alumina, lanthana doped alumina, ceria doped alumina, lanthana-zirconia doped alumina, and any combinations thereof.

Generally, the amount of the refractory metal oxide is 10 to 90% by weight, if used, based on the total weight of a single coat layer.

The oxygen storage component (OSC) refers to an entity that has a multi-valence state and can actively react with oxidants such as oxygen or nitrogen oxides under oxidative conditions, or react with reductants such as carbon monoxide or hydrogen under reduction conditions. Typically, the oxygen storage component comprises one or more reducible rare earth metal oxides, such as ceria. The oxygen storage component may also comprise one or more of lanthana, praseodymia, neodymia, europia, samaria, ytterbia, yttria, zirconia and hafnia to constitute a composite oxide with ceria. Preferably, the oxygen storage component is selected from ceria-zirconia composite oxide and stabilized ceria-zirconia composite oxide. Generally, the amount of oxygen storage component is 20 to 80% by weight, if used, based on the total weight of a single coat layer.

There is no particular restriction to the support material for the first, second, third and fourth platinum components in the catalyst composition coat, which may be a refractory metal oxide, an oxygen storage component or any combinations thereof.

Preferably, the first platinum component may be supported on particles of an alumina-based material, an oxygen storage component or a combination thereof. More preferably, the first platinum component is supported on particles of a combination of an alumina-based material and a ceria-zirconia composite oxide, particularly a combination of ceria doped alumina and a ceria-zirconia composite oxide.

Preferably, the second platinum component may be supported on particles of an alumina-based material, an oxygen storage component or a combination thereof. More preferably, the second platinum component is supported on particles of a combination of an alumina-based material and a ceria-zirconia composite oxide, particularly a combination of ceria doped alumina and a ceria-zirconia composite oxide.

The third and fourth platinum components are also preferably supported on particles of an alumina-based material, an oxygen storage component or a combination thereof. More preferably, the third platinum component is supported on particles of a combination of an alumina-based material and a ceria-zirconia composite oxide, particularly a combination of ceria doped alumina and a ceria-zirconia composite oxide. The fourth platinum component is more preferably supported on particles of an alumina-based material, particularly ceria doped alumina.

Also, there is no particular restriction to the support material for the first palladium component and the second palladium component (when present) in the catalyst composition coat, which may be supported on particles of a refractory metal oxide, an oxygen storage component or any combinations thereof. Preferably, the first palladium component is supported on particles of a refractory metal oxide, particularly an alumina-based material. More preferably, the first palladium component is supported on particles of alumina or lanthana doped alumina.

In some illustrative embodiments, the rhodium-free TWC catalytic article according to the present invention comprises a catalyst composition coat on a substrate, wherein the catalyst composition coat comprises,
a first region comprising
   i. a top layer comprising a first platinum component and a first palladium component, where the first platinum component is supported on particles of a combination of an alumina-based material and a ceria-zirconia composite oxide, and the first palladium component is supported on particles of an alumina-based material, and
   ii. a bottom layer comprising a second platinum component supported on particles of a combination of an alumina-based material and a ceria-zirconia composite oxide, and
optionally, a second region located downstream of the first region, and comprising
   iii. a top layer comprising a third platinum component in supported form, and
   iv. a bottom layer comprising a fourth platinum component in supported form.

In further illustrative embodiments, the rhodium-free TWC catalytic article according to the present invention comprises a catalyst composition coat on a substrate, wherein the catalyst composition coat comprises,
a first region comprising
   i. a top layer comprising a first platinum component and a first palladium component, where the first platinum component is supported on particles of a combination of ceria doped alumina and a ceria-zirconia composite oxide, and the first palladium component is supported on particles of alumina or lanthana doped alumina, and
   ii. a bottom layer comprising a second platinum component supported on particles of a combination of ceria doped alumina and a ceria-zirconia composite oxide, and
optionally, a second region located downstream of the first region, and comprising
   iii. a top layer comprising a third platinum component in supported form, and
   iv. a bottom layer comprising a fourth platinum component in supported form.

In some other illustrative embodiments, the rhodium-free TWC catalytic article according to the present invention comprises a catalyst composition coat on a substrate, wherein the catalyst composition coat comprises,
a first region comprising
   i. a top layer comprising a first platinum component and a first palladium component, where the first platinum component is supported on particles of a combination of an alumina-based material and a ceria-zirconia composite oxide and the first palladium component is supported on particles of an alumina-based material, and
   ii. a bottom layer comprising a second platinum component supported on particles of a combination of an alumina-based material and a ceria-zirconia composite oxide, and
optionally, a second region located downstream of the first region, and comprising
   iii. a top layer comprising a third platinum component supported on particles of a combination of an alumina-based material and a ceria-zirconia composite oxide, and
   iv. a bottom layer comprising a fourth platinum component supported on particles of an alumina-based material.

In some preferable illustrative embodiments, the rhodium-free TWC catalytic article according to the present invention comprises a catalyst composition coat on a substrate, wherein the catalyst composition coat comprises,
a first region comprising
   i. a top layer comprising a first platinum component and a first palladium component, where the first platinum component is supported on particles of a combination of ceria doped alumina and a ceria-zirconia composite oxide, and the first palladium component is supported on particles of alumina or lanthana doped alumina, and
   ii. a bottom layer comprising a second platinum component supported on particles of a combination of ceria doped alumina and a ceria-zirconia composite oxide, and
optionally, a second region located downstream of the first region, and comprising
   iii. a top layer comprising a third platinum component supported on particles of a combination of ceria doped alumina and a ceria-zirconia composite oxide, and
   iv. a bottom layer comprising a fourth platinum component supported on particles of ceria doped alumina.

In those illustrative embodiments as described above, it is preferred that the bottom layers in the first region and in the second region (when present), are substantially free of a palladium component, particularly substantially free of any platinum group metal components other than a platinum component.

According to the present invention, the rhodium-free TWC catalytic article may comprise the first and second platinum components in the first region of the catalyst composition coat in a total amount of 1 to 150 g/ft³, or 5 to 100 g/ft³, or 10 to 80 g/ft³, or 20 to 60 g/ft³, calculated as platinum element. Also, the rhodium-free TWC catalytic article may comprise the first palladium component in the first region in an amount of 1 to 150 g/ft³, or 5 to 100 g/ft³, or 10 to 80 g/ft³, or 20 to 60 g/ft³, calculated as palladium element.

In the catalyst composition coat of the rhodium-free TWC catalytic article, the first palladium component and the sum of the first and second platinum components may be present at a weight ratio in the range of 1:10 to 10:1, or 1:5 to 5:1, or 1:2 to 2:1, calculated as platinum element and palladium element respectively.

Moreover, the catalyst composition coat of the rhodium-free TWC catalytic article may comprise the first platinum component and the second platinum component at a weight ratio in the range of 1:10 to 5:1, or 1:5 to 2:1, or 1:2 to 1:1, calculated as platinum element.

According to the present invention, the rhodium-free TWC catalytic article may comprise the third and fourth platinum components in the second region of the catalyst composition coat in a total amount of 1 to 150 g/ft³, or 5 to 100 g/ft³, or 20 to 80 g/ft³, calculated as platinum element. Moreover, the second region of the catalyst composition coat may comprise the third platinum component and the fourth platinum component at a weight ratio in the range of 1:10 to 10:1, or 1:2 to 5:1, or 1:1 to 2:1, calculated as platinum element.

In the catalyst composition coat of the rhodium-free TWC catalytic article, the first region and the second region extend at a length ratio in the range of 1:10 to 10:1, or 5:1 to 1:5, or 4:1 to 1:4, or 3:1 to 1:3, or 2:1 to 1:1. The length refers to the length of the part of substrate on which the region extends when the first and second regions are carried on a single piece of substrate, or the length of the respective substrate when the first and second regions are carried on respective pieces of substrate.

Moreover, when the first region and the second region of the catalyst composition coat are carried on respective pieces of substrate, the volume ratio of the first region to the second region may be in the range of 1:30 to 30:1, or 1:20 to 20:1, or 1:10 to 10:1. The volume of a region refers to the spatial volume occupied by the region, i.e., the spatial volume occupied by the substrate on which the region is carried.

Generally, a total loading of the first region of the catalyst composition coat may be in the range of 0.2 to 10.0 g/in³, or 1.0 to 5.0 g/in³, or 1.5 to 3.0 g/in³. Alternatively or additionally, a total loading of the second region may be in the range of 0.2 to 5.0 g/in³, or 1.0 to 4.0 g/in³, or 1.5 to 3.0 g/in³.

The catalyst composition coat optionally comprises a stabilizer and/or a promoter as desired. Suitable stabilizer includes non-reducible oxides of metals selected from the group consisting of barium, calcium, magnesium, strontium and any combinations thereof. Preferably, one or more oxides of barium and/or magnesium are used as the stabilizer. Suitable promoter includes non-reducible oxides of rare earth metals selected from the group consisting of lanthanum, praseodymium, yttrium, cerium, tungsten, neodymium, gadolinium, samarium, hafnium and mixtures thereof.

The catalyst composition coat is generally carried on the substrate in form of “washcoat”. The term “washcoat” has its usual meaning in the art and refers to a thin, adherent coating of a catalytic or other material applied to a substrate. A washcoat is generally formed by preparing a slurry containing a certain solid content (e.g., 15 to 60% by weight) of particles in a liquid medium, which is then applied onto a substrate, dried and calcined to provide a washcoat layer.

The substrate as used herein refers to a structure that is suitable for withstanding conditions encountered in an exhaust stream from combustion engines, on which catalyst compositions are carried, typically in the form of washcoat. The substrate is generally a ceramic or metal honeycomb structure having fine, parallel gas flow passages extending from one end of the structure to the other.

Metallic materials useful for constructing the substrate may include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15% by weight of the alloy, for example 10 to 25% by weight of chromium, 3 to 8% by weight of aluminium, and up to 20% by weight of nickel. The alloys may also contain small or trace amounts of one or more metals such as manganese, copper, vanadium, titanium and the like. The surface of the metallic substrate may be oxidized at high temperature, e.g., 1000° C. or higher, to form an oxide layer on the surface of the substrate, improving the corrosion resistance of the alloy and facilitating adhesion of the washcoat layer to the metal surface.

Ceramic materials useful for constructing the substrate may include any suitable refractory material, e.g., cordierite, mullite, cordierite-alumina, silicon nitride, zircon mullite, spodumene, alumina-silica-magnesia, zircon silicate, sillimanite, magnesium silicates, zircon, petalite, alumina, and aluminosilicates.

Within the context of the present invention, a flow-through substrate is preferred, which has a plurality of fine, parallel gas flow passages extending from an inlet face to an outlet face of the substrate such that passages are open to fluid flow therethrough. The passages, which are essentially straight paths from their fluid inlet to their fluid outlet, are defined by walls on which the catalytic material is applied as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain 60 to 900, or even more gas inlet openings (i.e., cells) per square inch of cross section. For example, the substrate may have 200 to 750, more usually 300 to 600 cells per square inch (“cpsi”). The wall thickness of flow-through substrates may vary, with a typical range of 1 mil to 0.1 inches.

It is also possible that the substrate is a wall-flow substrate having a plurality of fine, parallel gas flow passages extending along from an inlet face to an outlet face of the substrate wherein alternate passages are blocked at opposite ends. The configuration requires the gas stream flow through the porous walls of the wall-flow substrate to reach the outlet face. The wall-flow substrates may contain up to 700 cells per square inch (cpsi), for example 100 to 400 cpsi and more typically 200 to 300 cpsi. The cross-sectional shape of the passages can vary as described above for the passages of the flow-through substrate. The wall thickness of wall-flow substrates may vary, with a typical range of 2 mils to 0.1 inches.

As used herein, a loading of a platinum group metal (PGM) such as Pd or Pt is defined as the weight of the PGM in the catalyst per unit volume of the substrate or substrate part on which the PGM is carried, in a unit of g/ft³. A loading of a coating layer is defined as the total weight of all components of the layer (i.e., PGM, support, binder, etc.) per unit volume of the substrate, in a unit of g/in³.

The rhodium-free TWC catalytic article according to the present invention may be prepared by any conventional methods known in the art without any restrictions. Typically, a washcoating method may be adopted wherein a slurry comprising catalyst particles of supported PGM(s), optionally a stabilizer and/or promoter or precursors thereof, a solvent (e.g. water), optionally a binder, and optionally auxiliaries such as surfactant, pH adjustor and thickener is applied onto a substrate.

The catalyst particles of supported PGM(s) may be prepared by impregnating precursors of the PGM(s) such as soluble salts and/or complex thereof via conventional techniques such as incipient wetness impregnation or capillary impregnation on respective supports, optionally followed by drying and/or calcining. Suitable precursors of the PGMs may be selected from ammine complex salts, hydroxyl salts, nitrates, carboxylic acid salts, ammonium salts, and oxides. Non-limiting examples include palladium nitrate, tetraammine palladium nitrate, tetraammine platinum acetate, platinum nitrate, tetraammine platinum acetate and hexahydroxyplatinic acid diethanolamine salt ((HOCH₂CH₂NH₃)₂[Pt(OH)₆]).

The binder may be provided from one or more of alumina, boehmite, silica, zirconium acetate, colloidal zirconia and zirconium hydroxide. When present, the binder is typically used in an amount of 0.5 to 5.0% by weight of the total washcoat loading.

The slurries may have a solid content for example in the range of 20 to 60% by weight, more particularly 30 to 50% by weight. The slurries are often milled to reduce the particle size. Typically, the slurries may have a D₉₀ particle size of 3.0 to 40 microns, preferably 10 to 30 microns after milling, as measured by laser diffraction particle size distribution analyzer.

The applied slurry may be dried at an elevated temperature (e.g., 100 to 150° C.) for a period of time (e.g., 10 minutes to 3 hours) and calcined at a higher temperature (e.g., 400 to 700° C.) typically for 10 minutes to 3 hours to be deposited on the substrate. The washcoat loading after calcination can be determined through calculation of the weight difference between the coated and uncoated substrate. As will be apparent to those of skill in the art, the washcoat loading can be modified by altering the slurry rheology. In addition, the deposition process including coating, drying and calcining to generate a washcoat can be repeated as needed to build a layer to the desired loading level or thickness, which means more than one washcoat may be applied.

According to another aspect of the present invention, an exhaust treatment system is provided, which comprises the rhodium-free TWC catalytic article as described herein located downstream of a stoichiometric engine, particularly a gasoline engine. In some embodiments, the exhaust treatment system is particularly useful for a motorcycle.

According to a further aspect of the present invention, a method for treating an exhaust stream, particularly from a stoichiometric engine is provided, which includes contacting the exhaust stream with the rhodium-free TWC catalytic article or the exhaust treatment system as described herein. Particularly, the present invention provides a method for treating an exhaust stream from a gasoline engine, preferably a motorcycle engine.

### Embodiments

Various embodiments are listed below. It will be understood that the embodiments listed below may be combined with all aspects and other embodiments in accordance with the scope of the invention.
Embodiment 1. A rhodium-free TWC catalytic article, which comprises a catalyst composition coat on a substrate, wherein the catalyst composition coat comprises,
   a first region comprising
      i. a top layer comprising a first platinum component and a first palladium component, each being present in supported form, and
      ii. a bottom layer comprising a second platinum component in supported form, and
   optionally, a second region located downstream of the first region, and comprising
      iii. a top layer comprising a third platinum component in supported form, and
      iv. a bottom layer comprising a fourth platinum component in supported form.
Embodiment 2. The rhodium-free TWC catalytic article according to Embodiment 1, wherein the catalyst composition coat comprises only the first region, preferably the bottom layer in the first region is substantially free of a palladium component.
Embodiment 3. The rhodium-free TWC catalytic article according to Embodiment 1, wherein the catalyst composition coat comprises the second region.
Embodiment 4. The rhodium-free TWC catalytic article according to Embodiment 3, wherein the top layer of the second region of the catalyst composition coat is substantially free of a palladium component.
Embodiment 5. The rhodium-free TWC catalytic article according to Embodiment 3, wherein the top layer of the second region of the catalyst composition coat comprises the third platinum component and a second palladium component, each being in supported form.
Embodiment 6. The rhodium-free TWC catalytic article according to any of preceding Embodiments 3 to 5, wherein the bottom layers in the first region and in the second region of the catalyst composition coat are substantially free of a palladium component.
Embodiment 7. The rhodium-free TWC catalytic article according to any of preceding Embodiments, wherein the supports for each platinum components and each palladium components are independently selected from refractory metal oxides such as alumina-based materials, oxygen storage components and any combinations thereof.
Embodiment 8. The rhodium-free TWC catalytic article according to Embodiment 7, wherein the alumina-based materials are selected from baria doped alumina, lanthana doped alumina, ceria doped alumina, lanthana-zirconia doped alumina, and any combinations thereof.
Embodiment 9. The rhodium-free TWC catalytic article according to Embodiment 7, wherein the oxygen storage component is selected from ceria-zirconia composite oxide, stabilized ceria-zirconia composite oxide, and any combinations thereof.
Embodiment 10. The rhodium-free TWC catalytic article according to any of preceding Embodiments, wherein the first platinum component is supported on particles of a combination of an alumina-based material and a ceria-zirconia composite oxide, particularly a combination of ceria doped alumina and a ceria-zirconia composite oxide.
Embodiment 11. The rhodium-free TWC catalytic article according to any of preceding Embodiments, wherein the second platinum component is supported on particles of a combination of an alumina-based material and a ceria-zirconia composite oxide, particularly a combination of ceria doped alumina and a ceria-zirconia composite oxide.
Embodiment 12. The rhodium-free TWC catalytic article according to any of preceding Embodiments, wherein the third platinum component is supported on particles of a combination of an alumina-based material and a ceria-zirconia composite oxide, particularly a combination of ceria doped alumina and a ceria-zirconia composite oxide.
Embodiment 13. The rhodium-free TWC catalytic article according to any of preceding Embodiments, wherein the fourth platinum component is supported on particles of an alumina-based material, particularly ceria doped alumina.
Embodiment 14. The rhodium-free TWC catalytic article according to any of preceding Embodiments, wherein the first palladium component is supported on particles of an alumina-based material, particularly alumina or lanthana doped alumina.
Embodiment 15. The rhodium-free TWC catalytic article according to any of preceding Embodiments, wherein the first palladium component and the sum of the first and second platinum components are comprised at a weight ratio in the range of 1:10 to 10:1, or 1:5 to 5:1, or 1:2 to 2:1, calculated as palladium element and palladium element respectively.
Embodiment 16. The rhodium-free TWC catalytic article according to any of preceding Embodiments, wherein the first platinum component and the second platinum component are comprised at a weight ratio in the range of 1:10 to 5:1, or 1:5 to 2:1, or 1:2 to 1:1, calculated as platinum element.
Embodiment 17. The rhodium-free TWC catalytic article according to any of preceding Embodiments 3 to 16, wherein the third platinum component and the fourth platinum component are comprised at a weight ratio in the range of 1:10 to 10:1, or 1:2 to 5:1, or 1:1 to 2:1, calculated as platinum element.
Embodiment 18. The rhodium-free TWC catalytic article according to any of preceding Embodiments, wherein the substrate is a flow-through substrate or a wall-flow substrate.
Embodiment 19. An exhaust treatment system, which comprises the rhodium-free TWC catalytic article as defined in any of Embodiments 1 to 18 located downstream of a stoichiometric engine.
Embodiment 20. The exhaust treatment system according to Embodiment 19, wherein the stoichiometric engine is a gasoline engine, particularly a motorcycle engine.
Embodiment 21. A method for treating an exhaust stream, particularly from a stoichiometric engine, which includes contacting the exhaust stream with the rhodium-free TWC catalytic article as defined in any of Embodiments 1 to 18 or the exhaust treatment system as defined in Embodiment 19 or 20.
Embodiment 22. The method according to Embodiment 21, wherein the exhaust stream is from a gasoline engine, preferably a motorcycle engine.

### EXAMPLES

Aspects of the present invention are more fully illustrated by the following examples, which are set forth to illustrate certain aspects of the present invention and are not to be construed as limiting thereof.

### Example 1 Preparation of Catalyst Modules

### Example 1.1 Preparation of a Catalyst Module Having a Layered Catalyst Composition Coat Comprising Pt as the PGM

### Bottom Coating Slurry:

30 grams of 16% aqueous hexahydroxyplatinic acid diethanolamine ((MEA)₂Pt(OH)₆) solution was impregnated onto 360 grams of ceria-alumina (20% CeO₂) powder via incipient wetness impregnation. Then the obtained powder was added in a solution containing 150 grams of D.I. water, 27 grams of barium nitrate powder and 83 grams of magnesium acetate powder with continuous stirring, with the pH being adjusted to 5.0 by nitric acid. After that, 21 grams of alumina binder was added and then milled to a D₉₀ of 20 microns.

### Top Coating Slurry:

57 grams of 16% aqueous (MEA)₂Pt(OH)₆ solution was impregnated onto a mixture of 215 grams of ceria-alumina (20% CeO₂) powder and 121 grams of ceria-zirconia (40% CeO₂) powder via incipient wetness impregnation, and then the obtained powder was added in 300 grams of D.I. water, and then milled to a D₉₀ of 20 microns. After that, 96 grams of 28% cerium nitrate solution and 33 grams of alumina binders were added to the solution with the pH being adjusted to 5.0 by nitric acid.

### Catalyst Module:

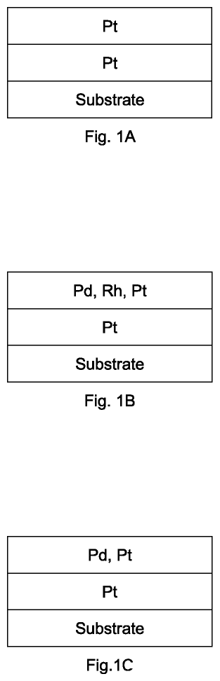

The bottom coating slurry was coated onto a 300/2 (cpsi/mil) flow-through metallic substrate with diameter of 40 mm and length of 90 mm, dried at 150° C. for 1 hour and then calcined at 500° C. for 2 hours. The bottom coating layer was obtained with a washcoat loading of 1.0 g/in³ and the Pt loading of the bottom coating layer is 20 g/ft³. The top coating slurry was then applied, dried at 150° C. for 1 hour and then calcined at 500° C. for 2 hours. The top coating layer was obtained with a washcoat loading of 1.0 g/in³ and the Pt loading of the top coating layer is 40 g/ft³. A schematic representation of this module is provided in FIG. 1A.

### Example 1.2 Preparation of a Catalyst Module Having a Layered Catalyst Composition Coat Comprising Pt, Pd and Rh as the PGMs

### Bottom Coating Slurry:

16 grams of 16% aqueous (MEA)₂Pt(OH)₆ solution was impregnated onto 78 grams of ceria-alumina (20% CeO₂) powder and 261 grams of ceria-zirconia (45% CeO₂) powder via incipient wetness impregnation. The product was mixed with 200 grams of D.I. water and then 49 grams of barium sulfate powder and 44 grams of alumina binder were added and milled to a D₉₀ of 20 microns. The pH was then adjusted to 5.0 by addition of nitric acid.

### Top Coating Slurry:

A first component was prepared by impregnating 25 grams of 20% aqueous palladium nitrate solution onto 242 grams of alumina powder via incipient wetness impregnation.

A second component was prepared by impregnating 5 grams of 10% aqueous rhodium nitrate solution onto 30 grams of lanthanum-zirconia-alumina (3% La₂O₃, 20% ZrO₂) powder and 90 grams of ceria-zirconia (22% CeO₂) powder via incipient wetness impregnation.

13 grams of 16% aqueous (MEA)₂Pt(OH)₆ solution was diluted in 200 grams of D.I. water and then the first and second components were added with the pH being adjusted to 5.0 by nitric acid. Then, the slurry was milled to a D₉₀ of 20 microns, and 7 grams of barium sulfate powder was added. After that, 113 grams of alumina binder was added.

### Catalyst Module:

The bottom coating slurry was coated onto a 300 cpsi/2 (cpsi/mil) flow-through metallic substrate with diameter of 40 mm and length of 90 mm, dried at 150° C. for 1 hour and then calcined at 500° C. for 2 hours. The bottom coating layer was obtained with a washcoat loading of 1.5 g/in³ and the Pt loading of the bottom coating layer is 16.5 g/ft³. The top coating slurry was then applied, dried at 150° C. for 1 hour and then calcined at 500° C. for 2 hours. The top coating layer was obtained with a washcoat loading of 1.3 g/in³ and the PGM loading of the top coating layer consists of 12.1 g/ft³ Pt, 28.6 g/ft³ Pd and 2.9 g/ft³ Rh. A schematic representation of this module is provided in FIG. 1B.

### Example 1.3 Preparation of a Catalyst Module Having a Layered Catalyst Composition Coat Comprising Pt and Pd as the PGMs

### Bottom Coating Slurry:

14 grams of 16% aqueous (MEA)₂Pt(OH)₆ solution was impregnated onto 83 grams of ceria-alumina (20% CeO₂) powder and 300 grams of ceria-zirconia (45% CeO₂) powder via incipient wetness impregnation. The product was mixed with 300 grams of D.I. water and then 14 grams of barium acetate powder and 33 grams of alumina binder were added and milled to a D₉₀ of 20 microns. The pH was then adjusted to 5.0 by nitric acid.

### Top Coating Slurry:

A first component was prepared by impregnating 27 grams of 20% aqueous palladium nitrate solution onto 138 grams of alumina powder via incipient wetness impregnation.

A second component was prepared by impregnating 11 grams of 16% aqueous (MEA)₂Pt(OH)₆ solution onto 184 grams of ceria-zirconia (22% CeO₂) powder and 61 grams of ceria-alumina (20% CeO₂) powder via incipient wetness impregnation.

The first and second components were added in 185 grams of D.I. water with the pH being adjusted to 5.0 by nitric acid. The slurry was milled to a D₉₀ of 20 microns, and 4 grams of barium sulfate powder and 31 grams of alumina binder were added.

### Catalyst Module:

The bottom coating slurry was coated onto a 300 cpsi/2 (cpsi/mil) flow-through metallic substrate with diameter of 40 mm and length of 90 mm, dried at 150° C. for 1 hour and then calcined at 500° C. for 2 hours. The bottom coating layer was obtained with a washcoat loading of 2.0 g/in³ and the Pt loading of the bottom coating layer is 20 g/ft³. The top coating slurry was then applied, dried at 150° C. for 1 hour and then calcined at 500° C. for 2 hours. The top coating layer was obtained with a washcoat loading of 1.3 g/in³ and the PGM loading of the top coating layer consists of 10 g/ft³ Pt and 30 g/ft³ Pd. A schematic representation of this module is provided in FIG. 1C.

### Example 2 Preparation of Test Samples

Test samples with region arrangements as shown in Table 1 were prepared by accommodating respective modules into a housing with an inlet and an outlet for the gas stream to be treated.

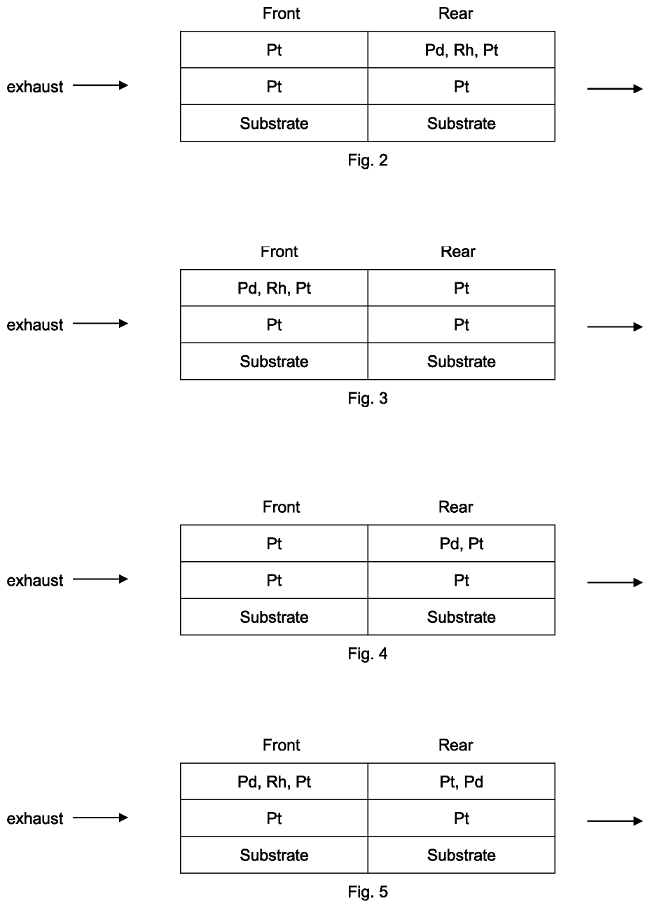

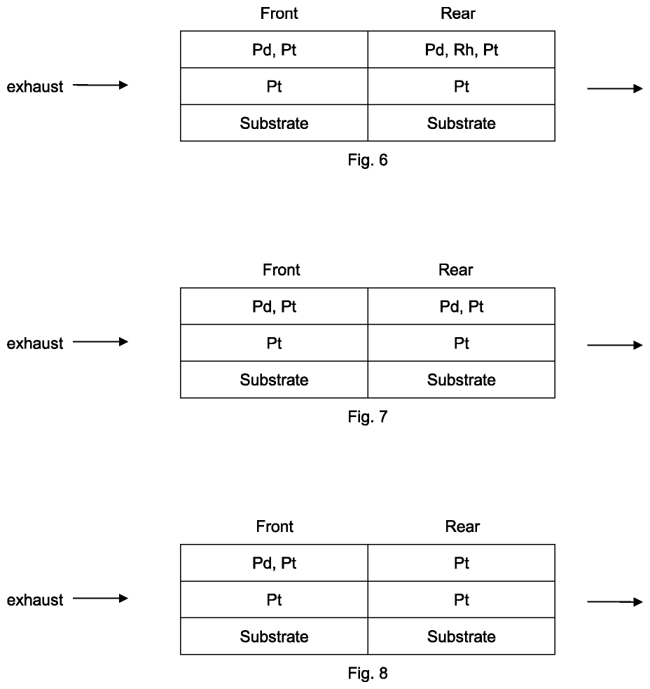

The configurations of samples R1 to R5 and S1 to S2 are schematically shown in FIGS. 2 to 8 respectively.

TABLE 1

| | Front Region (inlet region) | Rear Region (outlet region) |
|---|---|---|
| Sample No. | Module | Module |
| R1 (Comp.*) | Example 1.1 | Example 1.2 |
| R2 (Comp.) | Example 1.2 | Example 1.1 |
| R3 (Comp.) | Example 1.1 | Example 1.3 |
| R4 (Comp.) | Example 1.2 | Example 1.3 |
| R5 (Comp.) | Example 1.3 | Example 1.2 |
| S1 (Inv.**) | Example 1.3 | Example 1.3 |
| S2 (Inv.) | Example 1.3 | Example 1.1 |

*Comp.: comparative configuration;
**Inv.: inventive configuration

### Example 3 Catalytic Performance Test

The test was carried out on a 125 cc motorbike using the World Motorcycle Test Cycle (WMTC) in accordance with GB14622-2016, Type I. The performance of the test samples in fresh state was evaluated by measuring the tail-pipe non-methane hydrocarbons (NMHC), total hydrocarbons (THC), CO and NOx emissions from following two phases included in one test cycle:
P1: Cold start phase from 0 to 600 seconds,
P2: Hot phase from 600 to 1200 seconds.

The exhausts from the two phases have following accumulative compositions under fuel consumption of 2.17 L/100 km:
P1: 2.200 g/km CO, 0.499 g/km THC, 0.440 g/km NOx,
P2: 1.660 g/km CO; 0.389 g/km THC; 0.493 g/km NOx.

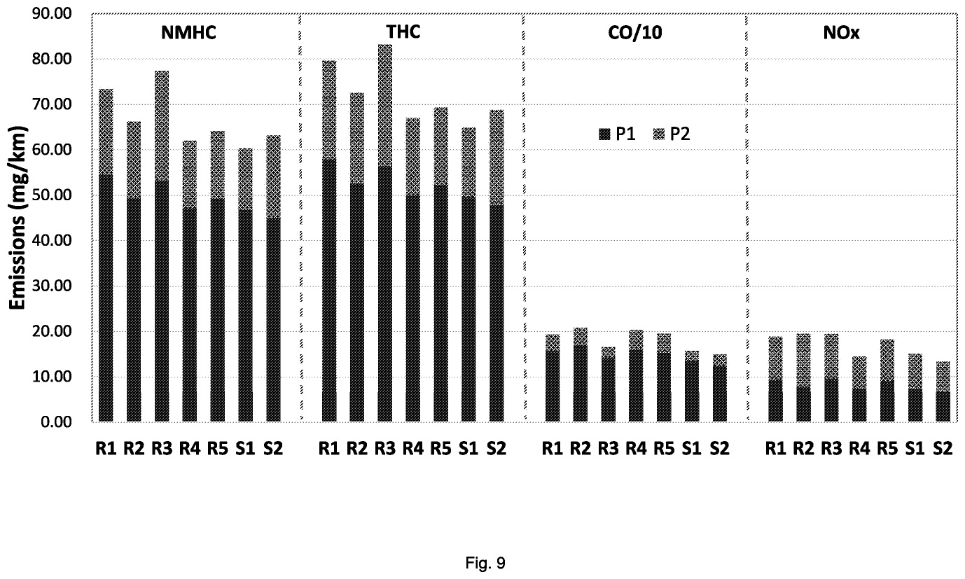

Each sample was tested for three times to provide an average as the test result, which are shown in Tables 2 to 5. The test results of the emissions are also shown graphically in FIG. 9.

TABLE 2
Tail-pipe NMHC Emissions (mg/km)

| NMHC | R1 | R2 | R3 | R4 | R5 | S1 | S2 |
|---|---|---|---|---|---|---|---|
| P1 Avg. | 54.6 | 49.4 | 53.3 | 47.1 | 49.3 | 46.8 | 45.1 |
| P2 Avg. | 18.8 | 16.8 | 24.1 | 14.9 | 14.9 | 13.5 | 18.1 |
| Psum Avg. | 73.4 | 66.2 | 77.4 | 62.0 | 64.1 | 60.3 | 63.2 |

TABLE 3
Tail-pipe THC Emissions (mg/km)

| THC | R1 | R2 | R3 | R4 | R5 | S1 | S2 |
|---|---|---|---|---|---|---|---|
| P1 Avg. | 57.9 | 52.6 | 56.4 | 50.0 | 52.2 | 49.6 | 47.9 |
| P2 Avg. | 21.7 | 20.0 | 26.8 | 17.1 | 17.1 | 15.3 | 20.9 |
| Psum Avg. | 79.6 | 72.6 | 83.2 | 67.0 | 69.3 | 64.9 | 68.8 |

TABLE 4
Tail-pipe CO Emissions (mg/km)

| CO/10 | R1 | R2 | R3 | R4 | R5 | S1 | S2 |
|---|---|---|---|---|---|---|---|
| P1 Avg. | 15.8 | 17.0 | 14.3 | 16.1 | 15.4 | 13.5 | 12.4 |
| P2 Avg. | 3.6 | 3.8 | 2.3 | 4.3 | 4.2 | 2.2 | 2.5 |
| Psum Avg. | 19.4 | 20.8 | 16.6 | 20.3 | 19.6 | 15.7 | 15.0 |

TABLE 5
Tail-pipe NOx Emissions(mg/km)

| NOx | R1 | R2 | R3 | R4 | R5 | S1 | S2 |
|---|---|---|---|---|---|---|---|
| P1 Avg. | 9.4 | 7.8 | 9.6 | 7.5 | 9.1 | 7.4 | 6.7 |
| P2 Avg. | 9.5 | 11.7 | 9.8 | 7.0 | 9.2 | 7.7 | 6.7 |
| Psum Avg. | 18.9 | 19.5 | 19.5 | 14.5 | 18.3 | 15.1 | 13.4 |

It can be seen from the comparison between the test results of sample R1 and sample R3, elimination of Rh in the catalyst composition coat of a catalytic article resulted in significant increase of NMHC and THC emissions and appreciable increase of NOx emission, when Pd is present only in the rear region of the catalytic articles.

However, it was surprisingly found that elimination of Rh in the catalyst composition coat of a catalytic article resulted in decrease of NMHC, THC, CO and NOx emissions, when Pd is present in the front region or both regions of the catalytic articles, as can be seen from the comparisons of sample R2 with sample S2, sample R4 with sample S1, and sample R5 with sample S1.

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1. A rhodium-free TWC catalytic article, which comprises a catalyst composition coat on a substrate, wherein the catalyst composition coat comprises,
a first region comprising
i. a top layer comprising a first platinum component and a first palladium component, each being present in supported form, and
ii. a bottom layer comprising a second platinum component in supported form, and
optionally, a second region located downstream of the first region, and comprising
iii. a top layer comprising a third platinum component in supported form, and
iv. a bottom layer comprising a fourth platinum component in supported form.

2. The rhodium-free TWC catalytic article according to claim 1, wherein the catalyst composition coat comprises only the first region, preferably the bottom layer in the first region is substantially free of a palladium component.

3. The rhodium-free TWC catalytic article according to claim 1, wherein the catalyst composition coat comprises the second region.

4. The rhodium-free TWC catalytic article according to claim 3, wherein the top layer of the second region of the catalyst composition coat is substantially free of a palladium component.

5. The rhodium-free TWC catalytic article according to claim 3, wherein the top layer of the second region of the catalyst composition coat comprises the third platinum component and a second palladium component, each being in supported form.

6. The rhodium-free TWC catalytic article according to claim 3, wherein the bottom layers in the first region and in the second region of the catalyst composition coat are substantially free of a palladium component.

7. The rhodium-free TWC catalytic article according to claim 1, wherein the supports for each platinum components and each palladium components are independently selected from refractory metal oxides such as alumina-based materials, oxygen storage components and any combinations thereof.

8. The rhodium-free TWC catalytic article according to claim 7, wherein the alumina-based materials are selected from baria doped alumina, lanthana doped alumina, ceria doped alumina, lanthana-zirconia doped alumina, and any combinations thereof.

9. The rhodium-free TWC catalytic article according to claim 7, wherein the oxygen storage component is selected from ceria-zirconia composite oxide, stabilized ceria-zirconia composite oxide, and any combinations thereof.

10. The rhodium-free TWC catalytic article according to claim 1, wherein the first platinum component is supported on particles of a combination of an alumina-based material and a ceria-zirconia composite oxide, particularly a combination of ceria doped alumina and a ceria-zirconia composite oxide.

11. The rhodium-free TWC catalytic article according to claim 1, wherein the second platinum component is supported on particles of a combination of an alumina-based material and a ceria-zirconia composite oxide, particularly a combination of ceria doped alumina and a ceria-zirconia composite oxide.

12. The rhodium-free TWC catalytic article according to claim 1, wherein the third platinum component is supported on particles of a combination of an alumina-based material and a ceria-zirconia composite oxide, particularly a combination of ceria doped alumina and a ceria-zirconia composite oxide.

13. The rhodium-free TWC catalytic article according to claim 1, wherein the fourth platinum component is supported on particles of an alumina-based material, particularly ceria doped alumina.

14. (canceled)

15. The rhodium-free TWC catalytic article according to claim 1, wherein the first palladium component and the sum of the first and second platinum components are comprised at a weight ratio in the range of 1:10 to 10:1, or 1:5 to 5:1, or 1:2 to 2:1, calculated as palladium element and palladium element respectively.

16. (canceled)

17. The rhodium-free TWC catalytic article according to claim 3, wherein the third platinum component and the fourth platinum component are comprised at a weight ratio in the range of 1:10 to 10:1, or 1:2 to 5:1, or 1:1 to 2:1, calculated as platinum element.

18. The rhodium-free TWC catalytic article according to claim 1, wherein the substrate is a flow-through substrate or a wall-flow substrate.

19. An exhaust treatment system, which comprises the rhodium-free TWC catalytic article as defined in claim 1 located downstream of a stoichiometric engine.

20. The exhaust treatment system according to claim 19, wherein the stoichiometric engine is a gasoline engine, particularly a motorcycle engine.

21. A method for treating an exhaust stream, particularly from a stoichiometric engine, which includes contacting the exhaust stream with the rhodium-free TWC catalytic article as defined in claim 1.

22. The method according to claim 21, wherein the exhaust stream is from a gasoline engine, preferably a motorcycle engine.
